(19) United States
(12) Patent Application Publication
(10) Pub. No.: US 2025/0313689 A1
(43) Pub. Date: Oct. 9, 2025

(54) THERMOPLASTIC COMPOSITION FOR METAL PLATING

(71) Applicant: SABIC Global Technologies B.V., Bergen op Zoom (NL)

(72) Inventors: Amit Kumar Tevtia, Bengaluru (IN); Mohamed Ashraf Moideen, Bengaluru (IN); Dhanabalan Anantharaman, Bengaluru (IN); Sara Ali Abbas, Bengaluru (IN)

(21) Appl. No.: 18/865,109

(22) PCT Filed: Nov. 30, 2023
(86) PCT No.: PCT/EP2023/083673

§ 371 Date: Nov. 12, 2024

(30) Foreign Application Priority Data
Dec. 2, 2022 (EP) 22211168.4

(51) Int. Cl. C08L 25/12; C25D 5/56

(52) U.S. Cl. CPC C08L 25/12; C08L 2205/025; C08L 2205/035; C25D 5/56

(57) ABSTRACT

A thermoplastic composition for metal plating and a method of metal plating using the thermoplastic composition are described herein. The thermoplastic composition includes a copolymer in an amount from 30%-80% by weight of the composition. The copolymer includes polymeric units derived from a vinyl aromatic monomer and a vinyl nitrile monomer. The thermoplastic composition further includes a rubber modified polymer in an amount of 18%-50% by weight of the composition and a styrene maleic anhydride (SMA) copolymer in an amount from 2%-15% by weight of the composition. The SMA copolymer includes a maleic anhydride content in an amount from 10%-30% by weight of the SMA copolymer and the SMA copolymer comprises a weight average molecular weight from 5,000 g/mol to 30,000 g/mol.

### CROSS REFERENCE TO RELATED APPLICATIONS

This application claims priority to and the benefit of the filing date of European Patent Application No. 22211168.4, filed Dec. 2, 2022, which is incorporated herein by reference in its entirety.

### FIELD

The present disclosure relates to thermoplastic compositions for metal plating and methods of metal plating thermoplastic compositions.

### BACKGROUND

Polymeric plastic parts prepared from thermoplastic compositions, such as an acrylonitrile-butadiene-styrene (ABS) polymer, are often metalized when used for certain applications such as automotive applications. The thermoplastic composition functions as a polymeric substrate on which a metal coating can be deposited. For example, polymeric plastic parts prepared from an ABS polymer can be coated with a metal layer in order to impart a mirror finish look to resemble a metal part while retaining the distinct advantage of being lightweight. In addition, metal coatings can improve the mechanical strength, thermal stability, and chemical resistance of the underlying polymeric substrate on which the metal is coated. In this regard, ABS polymers are particularly useful for automotive and other industrial applications because of their desirable impact properties and other useful features.

However, there are some problems with the use of metal coatings on polymeric plastic parts. Metal coatings do not easily bond or adhere to most polymer based substrates unless the surfaces of such polymeric substrates are first chemically treated. Conventionally, a surface of a polymeric substrate can be chemically etched with oxidizing reagents such as hexavalent chromium trioxide or a mixture of chromic/sulfuric acids or chromic/sulfuric/phosphoric acids. These strong oxidizing agents can micro-roughen and chemically alter the surface of the polymeric substrate by forming polar organic functional groups such as R—COOH, R—OH, R—SO3 and R—CH═O at the surface of the substrate. The presence of these polar groups can promote adsorption of plating catalysts from aqueous solutions that allow subsequent metal deposition to occur during the plating process. After the etching process, the surface of the polymeric substrate can be metal plated. One suitable metric to measure the success of bonding between the metal layer and the polymer substrate is the peel strength, where greater peel strength correlates to better adherence of the metal on the polymer substrate.

However, the use of hexavalent chromium compounds such as chromium trioxide pose certain risks and challenges such as (1) health risks because such compounds are carcinogenic, (2) effective disposal of waste effluents derived from the etching process, which render such etching process not only environmentally hazardous but also expensive, (3) purification of the etched plastic parts to remove any residual chromium trioxide that may be present as impurities as such impurities adversely affect the metal plating process, and/or (4) the use of highly oxidizing acid solution may often damage the polymeric substrate itself or render it structurally weak for metal plating.

In an effort to avoid these problems, many alternative processes to chromic acid etching have been investigated. For example, a dry plasma etching process was proposed as an alternative for the wet etching process. However, application of this method is limited to flat polymeric parts. Alternatively, etching reagents such as potassium permanganate have been used in an attempt to replace chromic acid. Although, the use of heated alkaline permanganate solutions has seen some limited commercial success, owing to its slower oxidizing rate compared to chromic acid, applicability of permanganate solutions has mostly been limited. It is commercially desirable to obtain as a strong a bond as possible between a surface of a thermoplastic article and an electroless metal deposited thereon in order to enable facile electroplating.

### SUMMARY

Illustrative embodiments of the present disclosure are directed to a thermoplastic composition for metal plating. The thermoplastic composition includes a first copolymer in an amount from 30%-80% by weight of the composition. The first copolymer includes polymeric units derived from a vinyl aromatic monomer and a vinyl nitrile monomer. The thermoplastic composition further includes a rubber modified polymer in an amount of 18%-50% by weight of the composition and a styrene maleic anhydride (SMA) copolymer in an amount from 2%-15% by weight of the composition. The SMA copolymer includes a maleic anhydride content in an amount from 10%-30% by weight of the SMA copolymer and the SMA copolymer comprises a weight average molecular weight from 5,000 g/mol to 30,000 g/mol.

In some embodiments, the vinyl aromatic monomer includes at least one of styrene, α-methyl styrene, dibromostyrene, vinyltoluene, vinylxylene, butylstyrene, p-hydroxystyrene, and methoxystyrene (preferably the vinyl aromatic monomer is styrene) and the vinyl nitrile monomer includes at least one of acrylonitrile, chloroacrylonitrile, methacrylonitrile, and ethacrylonitrile (preferably the vinyl nitrile monomer is acrylonitrile).

In some embodiments, the rubber modified polymer includes a polymeric rubber with polymeric units derived from a conjugated diene and the rubber modified polymer also includes a grafted thermoplastic copolymer grafted to the polymeric rubber.

In some embodiments, the rubber modified polymer includes a polymeric rubber with polymeric units derived from a conjugated diene. The conjugated diene includes at least one of 1,3-butadiene, isoprene, 1,3-heptadiene, methyl-1,3-pentadiene, 2,3-dimethyl-1,3-butadiene, 2-ethyl-1,3-pentadiene, 1,3-hexadiene, and 2,4-hexadiene (preferably 1,3-butadiene). The rubber modified polymer also includes a grafted thermoplastic copolymer grafted to the polymeric rubber. The grafting thermoplastic copolymer includes polymeric units derived from a vinyl aromatic monomer (preferably styrene) and a vinyl nitrile monomer (preferably acrylonitrile).

In some embodiments, the first copolymer includes a styrene-acrylonitrile copolymer (SAN) and the rubber modified polymer includes a SAN grafted butadiene rubber.

In some embodiments, the thermoplastic composition further includes an ethylene acrylic acid (EAA) copolymer in an amount from 2%-10% by weight of the composition. The EAA copolymer includes acrylic acid content in an amount from 1%-10% by weight of the EAA copolymer, preferably from 5%-7% by weight of the EAA copolymer.

In some embodiments, the thermoplastic composition includes one or more further components in an amount from 0%-5% by weight of the composition.

In some embodiments, the one or more further components in the thermoplastic composition are selected from the group consisting of an impact modifier, a flow modifier, a reinforcing agent, an antioxidant, a heat stabilizer, a light stabilizer, an ultraviolet light stabilizer, an ultraviolet absorbing additive, a plasticizer, a lubricant, a releasing agent, an antistatic agent, melt processing additive, and any combination thereof.

In some embodiment, the one or more further components includes at least one of magnesium oxide (MgO), silicone fluid, ethylene bis stearamide (EBX) wax, and magnesium stearate.

In some embodiments, the thermoplastic composition has a Notched Izod Impact strength of 3.0 kJ/m2 to 30.0 kJ/m2, preferably 4.0 kJ/m2 to 25.0 kJ/m2, more preferably 5.0 KJ/m2to 20.0 kJ/m2, when measured in accordance with ISO 180/1A.

Various embodiments of the present disclosure are directed to an electroplating process that includes molding a thermoplastic composition to form a molded article and thereafter depositing metal on the molded article to produce a metal plated molded article having a high peel strength and good impact properties. The method includes (i) molding the thermoplastic composition into a molded article, (ii) optionally cleaning and/or rinsing the molded article; (iii) contacting a surface of the molded article with a chemical agent to form a surface treated article; and (iv) subjecting the surface treated article to conditions suitable to adhere one or more metal layers to at least a portion of a surface of the surface treated article to produce a metal plated molded article.

In some embodiments, the chemical agent includes a suspension of manganese oxide colloidal particles in a mineral acid mixture comprising sulfuric acid and/or phosphoric acid.

In some embodiments, the one or more metal layers are selected from the group consisting of copper, nickel, and chromium (preferably nickel).

In some embodiments, the metal plated molded article has a peel strength determined in accordance with ASTM B533-85 of greater than 0.4 N/mm.

Further embodiments of the present disclosure are directed to a thermoplastic composition to be used for preparing metal plated articles suitable for various industrial applications that desire materials to have excellent impact strength. Also, and in one aspect, the thermoplastic composition of the present disclosure can be coated with metal without having to use chemical etching processes that rely on oxidizing reagents such as hexavalent chromium trioxide or a mixture of chromic/sulfuric acids or chromic/sulfuric/phosphoric acids.

Illustrative embodiments of the present disclosure are also directed to a metal plated article that includes a metal layer and a thermoplastic article. The metal layer is adhered onto at least a portion of a surface of the thermoplastic article. The thermoplastic article includes a copolymer in an amount from 30%-80% by weight of the composition. The copolymer includes polymeric units derived from a vinyl aromatic monomer and a vinyl nitrile monomer. The thermoplastic composition further includes a rubber modified polymer in an amount of 18%-50% by weight of the composition and a styrene maleic anhydride (SMA) copolymer in an amount from 2%-15% by weight of the composition. The SMA copolymer includes a maleic anhydride content in an amount from 10%-30% by weight of the SMA copolymer and the SMA copolymer comprises a weight average molecular weight from 5,000 g/mol to 30,000 g/mol.

In some embodiments, the metal plated article is an automotive or electrical part.

### BRIEF DESCRIPTION OF THE DRAWINGS

The above and other features, aspects and advantages of the present disclosure are better understood when the following detailed description of the disclosure is read with reference to the accompanying drawings, in which:

FIG. 1 shows a plot of peel force (in N/mm) vs. peeling length (in mm) for Examples E2 and E6 and Comparative Example CE1 in accordance with various embodiments of the present disclosure.

### DETAILED DESCRIPTION

Illustrative embodiments of the present disclosure are directed to a thermoplastic composition. The thermoplastic composition includes a first copolymer in an amount from 30%-80% by weight of the composition. The copolymer includes polymeric units derived from a vinyl aromatic monomer and a vinyl nitrile monomer. The thermoplastic composition further includes a rubber modified polymer in an amount of 18%-50% by weight of the composition and a styrene maleic anhydride (SMA) copolymer in an amount from 2%-15% by weight of the composition. The SMA copolymer includes a maleic anhydride content in an amount from 10%-30% by weight of the SMA copolymer and the SMA copolymer comprises a weight average molecular weight from 5,000 g/mol to 30,000 g/mol. Without intending to be bound by theory, the present inventors believe that the incorporation of SMA into ABS leads to polar anchor groups being present at a surface of a molded article (which includes the thermoplastic composition of the present disclosure). The presence of maleic anhydride groups in SMA increases surface energy and surface polarity at the surface of the molded article. These increases lead to better interfacial adhesion between ABS and a metal to be bonded to the surface of the molded article, thereby enabling facile metallization. Details of various embodiments are discussed below.

### Thermoplastic Composition

The thermoplastic composition described herein includes a first copolymer in an amount from 30%-80% by weight of the composition, preferably from 45%-75% by weight of the composition. The first copolymer comprises polymeric units derived from a vinyl aromatic monomer and a vinyl nitrile monomer. The thermoplastic composition also incudes a rubber modified polymer in an amount of 18%-50% by weight of the composition, preferably from 30%-45% by weight of the composition. The thermoplastic composition also includes a styrene maleic anhydride (SMA) copolymer in an amount from 2%-15% by weight of the composition. The SMA copolymer comprises a maleic anhydride content in an amount from 10%-30% by weight of the SMA copolymer, preferably from 12%-25% by weight of the SMA copolymer, more preferably from 15%-20% by weight of the SMA copolymer. The SMA copolymer comprises a weight average molecular weight from 5,000 g/mol to 30,000 g/mol, preferably from 10,000 g/mol to 25,000 g/mol, more preferably from 15,000 g/mol to 20,000 g/mol.

The thermoplastic composition can be molded or formed into a polymeric article. The polymeric article can have a suitable impact property necessary for certain applications including door handles, holders, lamp bodies, corporate logos, and other decorative components used in the automotive industry, household appliance, electronics, furniture, sanitary fittings and others. For example, the polymeric article can have a Notched Izod Impact strength of ≥3.0 kJ/m², preferably 4.0 kJ/m² to 25.0 kJ/m², more preferably from 5.0 kJ/m² to 20.0 kJ/m², when measured in accordance with ISO 180/1A.

### Copolymer (A)

The thermoplastic composition described herein comprises a copolymer which includes polymeric units derived from a vinyl aromatic monomer and a vinyl nitrile monomer. Based on the total weight of the thermoplastic composition, the first copolymer can be present in an amount from 30% to 80% by weight of the thermoplastic composition, preferably from 45% to 75% by weight of the thermoplastic composition, or any range or value there between.

Non-limiting example of vinyl aromatic monomers include styrene, a-methyl styrene, dibromostyrene, vinyltoluene, vinylxylene, butylstyrene, p-hydroxystyrene, methoxystyrene, or any combination thereof. Non-limiting examples of vinyl nitrile monomers include acrylonitrile, alpha-chloro acrylonitrile, methacrylonitrile, ethacrylonitrile, or any combination thereof. In one embodiment, the vinyl aromatic monomer is styrene and the vinyl nitrile monomer is acrylonitrile. Preferably, the copolymer is styrene acrylonitrile (SAN) copolymer. In preferred aspects of the disclosure, the copolymer may be styrene acrylonitrile copolymer having greater than or equal to 30.0% by weight and less than or equal to 35.0% by weight of polymeric units derived from acrylonitrile.

In some aspects of the disclosure, the copolymer can be a terpolymer comprising polymeric units derived from (i) a vinyl aromatic monomer, (ii) a vinyl nitrile monomer, and (iii) (meth)acrylic monomers. The vinyl aromatic monomer and the vinyl nitrile monomer can be selected from monomers as defined above. Non-limiting examples of (meth)acrylic monomers can include methyl methacrylate, ethyl methacrylate, propyl methacrylate, iso-propyl methacrylate, butyl methacrylate, hexyl methacrylate, and decyl methacrylate. Preferably, the (meth) acrylic monomer may be methyl methacrylate (MMA). Accordingly, the copolymer can be a terpolymer that includes polymeric units derived from styrene/acrylonitrile/methylmethacrylate or from alpha-methyl-styrene/acrylonitrile/methyl methacrylate.

The copolymer can have a suitable molecular weight and melt flow rate. A weight average molecular weight (Mw) of the copolymer can be from 50,000 g/mol to 100,000 g/mol or any range or value there between, as determined in accordance with gel permeation chromatography in accordance with ASTM D5296-11 using polystyrene based calibration with tetrahydrofuran (THF) as solvent.

The melt flow rate of the copolymer can be from 7.0 g/10 min to 40.0 g/10 min or any value or range there between as determined at 230° C. at 3.8 kg load in accordance with ASTM D1238. If the melt flow rate of the copolymer is above these rates, the overall impact property of the thermoplastic composition can be adversely affected whereas if the melt flow rate of the copolymer is below these rates, the desired flow property of the thermoplastic polymer is not attained, affecting the melt-processability of the thermoplastic polymer.

### Rubber Modified Polymer (B)

The thermoplastic composition described herein comprises a rubber modified polymer in an amount of 18%-50% by weight of the composition, or any range or value there between. The rubber modified polymer can be referred to as high rubber graft or “HRG”. The thermoplastic composition can include at least 26.0 by weight of the rubber modified polymer. In some aspects, the thermoplastic composition can include the rubber modified polymer present in an amount from 20.0 by weight to 50.0 by weight or any range or value there between, with regard to the total weight of the thermoplastic composition.

The rubber modified polymer, can include a suitable amount of the polymeric rubber, preferably from 55.0 by weight to 75.0 by weight with regard to the total weight of the rubber modified polymer. The polymeric rubber can include polymeric units derived from a conjugated diene. Non-limiting examples of the conjugated diene include 1,3-butadiene, isoprene, 1,3-heptadiene, methyl-1,3-pentadiene, 2,3-dimethyl-1,3-butadiene, 2-ethyl-1,3-pentadiene, 1,3-hexadiene, 2,4-hexadiene, and any combination thereof. Preferably, the conjugated diene is 1,3-butadiene and the polymeric rubber can be polybutadiene.

In a preferred aspect of the present disclosure, the rubber modified polymer comprises a polymeric rubber comprising polymeric units derived from 1,3-butadiene and a grafted thermoplastic copolymer grafted to the polymeric rubber. The grafting thermoplastic copolymer comprises polymeric units derived from a vinyl aromatic monomer, preferably styrene, and a vinyl nitrile monomer, preferably acrylonitrile. Most preferably the rubber modified polymer is acrylonitrile butadiene styrene (ABS).

### Styrene Maleic Anhydride Copolymer, SMA (C)

The thermoplastic composition described herein comprises a styrene maleic anhydride (SMA) copolymer in an amount from 2%-15% by weight of the composition, preferably from 5%-20% by weight of the composition, more preferably from 10%-15% by weight of the composition. The SMA copolymer comprises of styrene and maleic anhydride monomers. The SMA copolymer includes a maleic anhydride content in an amount from 10%-30% by weight of the SMA copolymer, preferably from 12%-25% by weight of the SMA copolymer, more preferably from 15%-20% by weight of the SMA copolymer. In various embodiments, the SMA copolymer comprises a weight average molecular weight from 5,000 g/mol to 30,000 g/mol, preferably from 10,000 g/mol to 25,000 g/mol, more preferably from 15,000 g/mol to 20,000 g/mol.

In general, SMAs are produced by reacting maleic anhydride with styrene at high temperatures in the presence of peroxide catalysts as shown in, for example, U.S. Pat. Nos. 2,866,771, 2,971,939, and the references cited therein. The copolymers can also be used instead of styrene such as methylstyrene, 2,4-Dimethylstyrene, chlorostyrenes and other substituted styrenes. The weight average molecular weight of the SMA copolymer can vary over a wide range, e.g., from about 5,000 g/mol to 30,000 g/mol, preferably from 10,000 g/mol to 25,000 g/mol, more preferably from 15,000 g/mol to 20,000 g/mol. A representative structure for SMA is shown in Scheme IA.

The thermoplastic composition may further comprises 2%-10% by weight of an ethylene acrylic acid (EAA) copolymer. The EAA copolymer can include 1% by weight to 10% by weight, preferably from 5% by weight to 7% by weight of acrylic acid, based on the total weight of the EAA copolymer. A representative structure for EAA is shown in Scheme I (B), where x=160 to 800 and y=4.8 to 35.

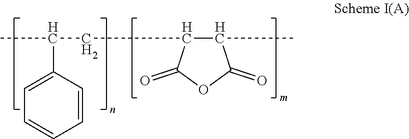

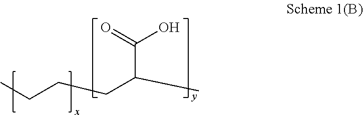

### Further Components (D)

The thermoplastic composition described herein can include one or more further components depending on the application and use. For example, the thermoplastic composition can include an amount of further component(s) from 0% to 5% by weight, preferably from 0% to 3% by weight based on the total weight of the thermoplastic composition.

Non-limiting examples of one or more further components that can be used include an impact modifier, a flow modifier, a reinforcing agent, an antioxidant, a heat stabilizer, a light stabilizer, an ultraviolet light stabilizer, an ultraviolet absorbing additive, a plasticizer, a lubricant, a releasing agent, an antistatic agent, melt processing additives, or any combination thereof.

The further component preferably comprises at least one melt processing additive. The melt processing additive may include magnesium oxide (MgO), silicone oil, ethylene bis(stearamide) wax (EBS wax), magnesium stearate, and combinations thereof. The melt processing additive(s) may be present in an amount from 0% by weight to 5% by weight, preferably from 1% by weight to 3% by weight based on the total weight of the thermoplastic composition.

### Thermoplastic Composition

The combination of specific types and amounts of materials constituting the thermoplastic composition described herein result in advantageous property profiles for impact performance and peel strength. The examples and comparative examples disclosed herein provide the skilled person with materials that fall inside and outside the scope of the disclosure and thereby constitute a basis for the development of further embodiments according to the disclosure.

For the avoidance of doubt the skilled person will understand that the total weight of the composition will be 100% by weight and that any combination of materials which would not form 100 by weight in total is unrealistic and not according to the disclosure.

In accordance with some embodiments of the disclosure, the thermoplastic composition is selected to have a notched Izod impact resistance determined in accordance with ISO 180/1A at a temperature of 23° C. of 3.0 kJ/m² to 30.0 kJ/m², preferably 4.0 kJ/m² to 25.0 kJ/m², more preferably 5.0 kJ/m² to 20.0 kJ/m²

Preferred ranges for the amount of the components and preferred ranges for the properties of the composition may be combined without limitation provided of course these fall within the ambit of the scope of the disclosure as defined herein in its broadest form. That is to say, a preferred range for one or more of the amounts and/or types of the components constituting the thermoplastic composition may be combined with a preferred range for one or more of the properties of the thermoplastic composition and all such combinations are considered as disclosed herein.

The compositions can be manufactured by various methods known in the art. For example, the first copolymer, the rubber modified polymer, SMA and other additives are first blended, in a high-speed mixer or by hand mixing. The blend is then fed into the throat of a twin-screw extruder via a hopper. Alternatively, at least one of the components can be incorporated into the composition by feeding it directly into the extruder at the throat and/or downstream through a side feeder, or by being compounded into a masterbatch with a desired polymer and fed into the extruder. For example, compositions can be prepared using a Krupp Werner & Pfleiderer ZSK2 co-rotating intermeshing 10-barrel twin screw extruder of diameter 25 mm and L/D ratio of 41. The temperature in the extruder may be from 180° C.-265° C. along the screw length. The extrudate can be immediately cooled in a water bath and pelletized. The pellets so prepared can be 0.6 cm in length or less as desired. Such pellets can be used for subsequent molding, shaping, or forming. The extruded form can be subjected to conditions suitable to produce a molded thermoplastic article. For example, thermoplastic pellets of the present disclosure can be injected molded into bars, sheets, or a form.

### Electroplating Process

One further subject of the disclosure is the use of the inventive polymer blend for electroplating. A further embodiment of the disclosure is a metal plated molded article comprising the aforementioned inventive thermoplastic composition. The surface of the molded article is at least partially or preferably totally coated with one or more metal layers (e.g., electroplated metal). The metal plated molded article is obtainable by usual processes for metal plating of thermoplastic composition such as (i) a conventional electroplating process or (ii) a direct plating process. Such processes have been already described and are known in the art. An electroplating process in accordance with the disclosure may comprise the following steps:
i. molding the thermoplastic composition as described herein into a molded article,
ii. optionally cleaning and/or rinsing the molded article,
iii. contacting a surface of the molded article with a chemical agent to form a surface treated article, and
iv. subjecting the surface treated article to conditions suitable to adhere one or more metal layers to at least a portion of the surface of the surface treated article to produce a metal plated molded article.

In some aspects of the disclosure, the molded article prepared from the thermoplastic composition of the present disclosure can be surface treated. Surface treatment can include contacting at least a portion of the thermoplastic composition (e.g., a molded thermoplastic composition) of the present disclosure with a chemical reagent for a sufficient time period (e.g., from 5.0 minutes to 30.0 minutes, preferably from 10.0 minutes to 20.0 minutes) to form the surface treated thermoplastic composition. Contact temperature can range from 60° C. to 80° C., preferably from 65.0° C. to 75.0° C. The surface treated polymeric article can have suitable surface polarity while retaining the desired impact strength. The attributes of surface polarity and impact strength can be attributed to a purposeful combination of a suitable polymeric article, a suitable selection of chemical reagent, and suitable process parameters of temperature and time period of contact/exposure.

Advantageously, in some embodiments, the surface treated article can be produced without the use of hexavalent chromium compounds thereby avoiding drawbacks associated with conventional etching process that use hexavalent chromium compounds. The article can be contacted with the chemical reagent for a suitable period of time in order to ensure the desired surface roughness is incorporated. For example, if the time period of contacting the article with the chemical reagent is too high (e.g., greater than 30 min), the surface of the article can be damaged. If the time period of contacting the article with the chemical reagent is too short (e.g., less than 5 minutes), the surface morphology of the article is not sufficiently altered to enable the adhesion of the surface treated article to a metal layer. The chemical reagent can be a suspension of a sulfuric acid solution (70.0 vol. %), manganese oxide colloidal particles suspended in a mineral acid mixture, potassium permanganate solution (6.5 vol. %), or any combination thereof. In some aspects, the chemical reagent can be a colloidal suspension that includes manganese oxide colloidal particles suspended in a mineral acid mixture of sulfuric acid and phosphoric acid. For example for a 1 liter solution, the manganese oxide colloidal particles can be present in an amount from 50.0 g/l to 70.0 g/l, the phosphoric acid can be present in an amount from 210.0 ml/l to 230.0 ml/l and the sulfuric acid can be present in an amount from 560.0 ml/l to 580.0 ml/l. The chemical reagent can include sulfuric acid (H₂SO₄) having a molar strength between 8.0 M to 14.0 M and/or phosphoric acid having molar strength between 2.0 M to 6.0 M. The surface treated article of illustrative embodiments of the present disclosure can retain advantageous impact properties even after the surface treatment with the chemical reagent.

In an aspect of the present disclosure, the surface treated article of the present disclosure can be metal plated by subjecting the article to conditions suitable to adhere one or more metal layers to at least a portion of the treated surface to form a metal plated molded article. The metal plating can be done by known metal plating techniques. For example, a combination of chemical plating and electroplating can be used herein. In one aspect, the surface treated article can be subjected to the chemical treatment to produce a metal plated precursor material. The metal plated precursor article can be contacted with a metal electrolyte solution at any applied electrical current (e.g., ≥1.0 Amps and ≤4.0 Amps, and for a time period of ≥5 minutes and ≤30 minutes) to produce the metal plated molded article.

The one or more metal layers are selected from the group consisting of copper, nickel, and chromium, preferably nickel. In accordance with the disclosure, at least a part of the surface of the molded article is coated with one or more metal layers. The thickness of a single layer may be in between 0.1 to 50 um. The metal plated molded article may have a peel strength determined in accordance with ASTM B533-85 of greater than 0.4 N/mm, preferably from 0.5 N/mm to 2.0 N/mm, more preferably from 0.6 N/mm to 1.5 N/mm.

In some embodiments, the metal plated molded article is incorporated into a housing component of an electrical or a consumer electronic device or an automotive bezel or reflector. It can also be used in door handles, holders, lamp bodies, corporate logos and many other decorative components used in the automotive industry, household appliances, electronics, furniture, sanitary fittings, and the like. In one aspect, the metal plated molded article is used in automotive applications and, in particular, exterior applications such as automotive front grilles and wheel covers.

The metal plated article molded from the thermoplastic composition of the present disclosure shows an improved adhesion between the metal layer and the plastic material. Furthermore the thermal cycling adherence is improved and the mechanical properties are excellent.

### EXAMPLES

The present disclosure will now be described using the following non-limiting examples to demonstrate the practice and advantages thereof. It is understood that the examples are given by way of illustration and are not intended to limit the specification of the claims to follow in any manner.

### Preparation of Thermoplastic Compositions of the Present Disclosure and Comparative Thermoplastic Compositions

All formulations were prepared on a 4 Kg scale. The components of the compositions and their source are listed in Table 1 while the details of the formulations are listed in the Table 2.

TABLE 1
Components of the compositions and their source.

| Component | Trade name/Supplier |
|---|---|
| HRG | CYCOLAC ™ INP 362, available from SABIC (rubber |
| | content ~62%) |
| SAN1 | INP 581 SAN, available from SABIC (~25% acrylonitrile |
| | content) |
| SAN2 | 55556 SAN, available from SABIC (~34% acrylonitrile |
| | content) |
| SMA1 | XIBOND 280, available from Polyscope polymers |
| | BV (~32% maleic anhydride content, 5K g/mole, by GPC) |
| SMA2 | XIBOND 220, available from Polyscope polymers |
| | BV (~18% maleic anhydride content, 15K g/mole, by GPC) |
| Mg Oxide | Available from Martin Marietta Magnesia Specialties |
| Silicone | Available from DOW chemical company |
| Fluid | |
| EBS Wax | Available from PMC Biogenix, Inc. |
| Mg Stearate | Available from Valtris Specialty Chemicals |

While a mixture of SAN pellets (A) and SMA (C) was added through a main hopper/feeder, a pre-blend of butadiene rubber (rubber modified thermoplastic polymer (B)) along with the melt processing additives of EBX wax, magnesium stearate, magnesium oxide, and silicone fluid) was fed through a side feeder connected to a second barrel (refer to Table 3). Comparative Example CE1 was prepared by mixing equal amounts of both SAN1 and SAN2 (copolymer (A)) without any SMA. Comparative Examples CE2 and CE3 and the Example thermoplastic compositions of the present disclosure (E1 to E11) were prepared in the same manner as the comparative samples, but before loading to the main hopper, the pellets of SMA (C) and the mixture of SANs were pre-mixed together in a plastic container to produce homogeneously mixed pellets. Similarly, a pre-blend in the form a homogeneous powder was obtained by dry-blending HRG and the melt processing additives in a separate plastic container. Melt processing 10 additives (MPA) were provided in an amount of: MgO (0.04%), Silicone fluid (0.2%), EBX wax (1%), Mg-Stearate (0.3%) for all the formulations.

TABLE 2
Formulations of the thermoplastic compositions.

| | HRG | SAN1 | SAN2 | SMA1 | SMA2 | MPA | Total |
|---|---|---|---|---|---|---|---|
| Sam- | (% by | (% by | (% by | (% by | (% by | (% by | (% by |
| ple # | weight) | weight) | weight) | weight) | weight) | weight) | weight) |
| CE1 | 24.28 | 37.09 | 37.09 | 0 | 0 | 1.54 | 100 |
| CE2 | 25 | 70.46 | 0 | 3 | 0 | 1.54 | 100 |
| CE3 | 25 | 63.46 | 0 | 10 | 0 | 1.54 | 100 |
| E1 | 25 | 70.46 | 0 | 0 | 3 | 1.54 | 100 |
| E2 | 40 | 48.46 | 0 | 0 | 10 | 1.54 | 100 |
| E3 | 25 | 0 | 63.46 | 0 | 10 | 1.54 | 100 |
| E4 | 40 | 0 | 52.46 | 0 | 6 | 1.54 | 100 |
| E5 | 25 | 63.46 | 0 | 0 | 10 | 1.54 | 100 |
| E6 | 32.5 | 62.96 | 0 | 0 | 3 | 1.54 | 100 |
| E7 | 32.5 | 59.96 | 0 | 0 | 6 | 1.54 | 100 |
| E8 | 25 | 0 | 70.46 | 0 | 3 | 1.54 | 100 |
| E9 | 25 | 0 | 63.46 | 0 | 10 | 1.54 | 100 |
| E10 | 40 | 0 | 55.46 | 0 | 3 | 1.54 | 100 |
| E11 | 40 | 0 | 48.46 | 0 | 10 | 1.54 | 100 |

The physically mixed formulations were melt blended in a 10-barrel Coperion ZSK-26 mm co-rotating twin-screw extruder having an L/D ratio of 40:1. The material throughput during extrusion was adjusted to maintain the specific mechanical energy (SME) between 0.172 and 0.185, while keeping the screw RPM at 250. Table 3 lists the temperature profile used during the extrusion of the formulations of the present disclosure.

TABLE 3

| Barrel | 1^{st} | 2^{nd} | 3^{rd} | 4^{th} | 5^{th} | 6^{th} | 7^{th} | 8^{th} | 9^{th} | 10^{th} |
|---|---|---|---|---|---|---|---|---|---|---|
| Temp ° C. | 170 | 204 | 225 | 230 | 240 | 240 | 240 | 240 | 240 | 245 |

Injection molding of test specimens such as ISO tensile bars, ISO impact bars, and 3 mm color plaques was carried out in an L&T Detech 100 Ton molding equipment fitted with a 32 mm diameter screw. Injection molding was conducted at a temperature of 240° C. and injection speed was maintained at 20 mm/sec. The molded plaques were kept for conditioning for 72 hours at 23° C. and 50% relative humidity (RH).

### Metal Plating of Molded Plaques of a Comparative Thermoplastic Composition and the Thermoplastic Compositions of the Present Disclosure

### Chemical Plating Process

A surface of each molded plaque was chemically plated by placing the plaque in a plating bath where metal ions in a plating bath were reduced and bound to the polar groups of polymeric plaques to form a metallic layer on the surface of the plaques. Before placing the plaques in the plating bath, all of the plaques (including the comparative and example thermoplastic compositions) were etched with hexachrome acid for 10 minutes at 70° C. in a conventional manner. All the pretreated plaques were sensitized in SnCl₂ (10 g/L)/HCl (40 mL/L) solution and activated in PdCl₂ (0.25 g/L)/HCl (2.5 mL/L) solution. The chemical plating bath contained CuSO_{4.}5H₂O (15 g/L), NaKC₄H₄O_{6.}4H₂O (30 g/L), HCHO (100 mL/L) and NaOH (4 g/L). All the samples were chemically plated for 15 minutes. Coated plaques were tested for their sheet resistance and were electroplated using the process described below.

### Electroplating Process

The electrodeposition experiment consisted of a copper deposition step and was carried out using a MiniContact RS Electroplating System. The electrolyte solution consisted of 75 g/L copper sulfate and 200 mL/L sulfuric acid. The applied current was 1.5 Amps and the temperature was 29° C. The plating time for both the comparative thermoplastic composition and the example thermoplastic compositions of the present disclosure was 30 min.

The process conditions for electroplating were optimized with respect to the applied current and the treatment time. Further, a statistically significant trend is identified for the metal growth on the plaques of formulated thermoplastic compositions of the present disclosure. Furthermore, thickness of metal layer grown on the surface of the plaque appeared to increase when the treatment time was varied from 5 to 30 min.

The different parameters (current and time) need to be considered in order to have a finite control on the metal thickness during the electroplating. To compare the final peel strength of different samples, a constant metal thickness was necessary in order to make sure that the difference in the peel strength arose mainly due to the different adhesion process i.e. chemical versus mechanical. However, in these examples, the surface conductivity for every sample was different depending on the chemical plating step. Due to this, all the samples were cut into the same diameters to maintain the same surface area. The electroplating was conducted on the same day while maintaining pH, electrolyte concentration, applied current, treatment time and temperature unchanged.

### Peel Testing of a Comparative Thermoplastic Composition and the Example Thermoplastic Compositions of the Present Disclosure

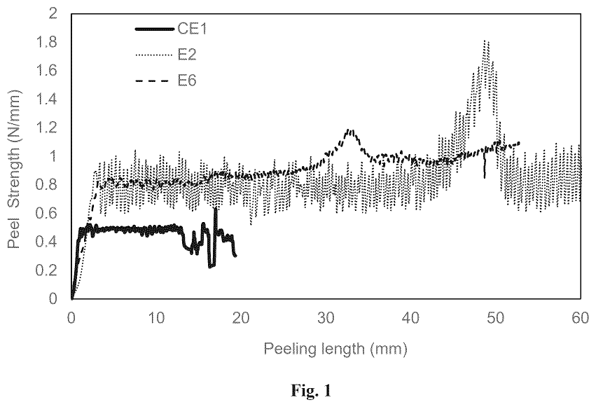

Example thermoplastic compositions of the present disclosure (E1 to E11) and the comparative examples (CE1 to CE3) were metalized and tested for peel adhesion. FIG. 1 shows a plot of peel force (in N/mm) vs. peeling length (in mm) for CE, E2 and E6. The peeling length and peel strength for the Examples was found to be much higher as compared to Comparative Example CE1. Table 4 shows the average peel strength determined in accordance with ASTM B533-85. Table 4 also shows the Notched Izod Impact (NII) strength of the molded article prepared with the thermoplastic composition, in accordance with ISO 180/1A.

From the results, it was determined that the textures provided using the thermoplastic compositions of the disclosure provided a better metal-plastic interlocking and good peeling forces as compared to the comparative thermoplastic composition that did not include the specific SMA of the disclosure.

TABLE 4
Average NII and Peel Strength value
for the experimental formulations

| Sample # | Peel Strength (N/mm) | NII (kJ/m²) |
|---|---|---|
| CE1 | 0.2 | 12.3 |
| CE2 | 0.4 | 10.5 |
| CE3 | 0.3 | 12.6 |
| E1 | 1.2 | 17.2 |
| E2 | 0.8 | 21.1 |
| E3 | 1.7 | 22.8 |
| E4 | 0.7 | 15.2 |
| E5 | 1.0 | 16.1 |
| E6 | 0.9 | 28.7 |
| E7 | 1.3 | 21.3 |
| E8 | 0.7 | 18.6 |
| E9 | 1.4 | 18.1 |
| E10 | 0.9 | 30.2 |
| E11 | 1.3 | 20.6 |

It will be understood that for the purposes of this disclosure that “at least one of X, Y, and Z” can be construed as X only, Y only, Z only, or any combination of two or more items X, Y, and Z (e.g., XYZ, XY, XZ, YZ). Furthermore, it will be understood that for the purposes of this disclosure, “X, Y, and/or Z” can be construed as X only, Y only, Z only, or any combination of two or more items X, Y, and Z (e.g., XYZ, XY, XZ, YZ).

Furthermore, it will be understood that for the purposes of this disclosure that where a range of numerical values is recited herein, comprising upper and lower values, unless otherwise stated in specific circumstances, the range is intended to include the endpoints thereof, and all integers and fractions within the range. It is not intended that the scope of the invention be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed.

While various embodiments of the disclosure have been shown and described, modifications to the various embodiments can be made without departing from the spirit and teachings of the disclosure. The embodiments and examples described herein are exemplary only, and are not intended to be limiting. Many variations and modifications of the disclosure disclosed herein are possible and are within the scope of the disclosure. Accordingly, the scope of protection is not limited by the description set out above but is only limited by the claims which follow, that scope including all equivalents of the subject matter of the claims. Each and every claim is incorporated into the specification as an embodiment of the present disclosure. Thus, the claims are a further description and are an addition to the detailed description of the present disclosure. The disclosures of all patents, patent applications, and publications cited herein are hereby incorporated by reference.

1. A thermoplastic composition comprising:
a first copolymer in an amount from 30%-80% by weight of the composition, preferably from 45%-75% by weight of the composition, wherein the first copolymer comprises polymeric units derived from a vinyl aromatic monomer and a vinyl nitrile monomer;
a rubber modified polymer in an amount of 18%-50% by weight of the composition, preferably from 30%-45% by weight of the composition; and
a styrene maleic anhydride (SMA) copolymer in an amount from 2%-15% by weight of the composition,
wherein the SMA copolymer comprises a maleic anhydride content in an amount from 10%-30% by weight of the SMA copolymer, preferably from 12%-25% by weight of the SMA copolymer, more preferably from 15%-20% by weight of the SMA copolymer, and
wherein the SMA copolymer comprises a weight average molecular weight from 5,000 g/mol to 30,000 g/mol, preferably from 10,000 g/mol to 25,000 g/mol, more preferably from 15,000 g/mol to 20,000 g/mol.

2. The thermoplastic composition of claim 1, wherein the vinyl aromatic monomer comprises at least one of styrene, α-methyl styrene, dibromostyrene, vinyltoluene, vinylxylene, butylstyrene, p-hydroxystyrene, and methoxystyrene, preferably the vinyl aromatic monomer is styrene, and the vinyl nitrile monomer comprises at least one of acrylonitrile, chloroacrylonitrile, methacrylonitrile, and ethacrylonitrile, preferably the vinyl nitrile monomer is acrylonitrile.

3. The thermoplastic composition of claim 2, wherein the rubber modified polymer comprises:
(i) a polymeric rubber comprising polymeric units derived from a conjugated diene, wherein the conjugated diene comprises at least one of 1,3-butadiene, isoprene, 1,3-heptadiene, methyl-1,3-pentadiene, 2,3-dimethyl-1,3-butadiene, 2-ethyl-1,3-pentadiene, 1,3-hexadiene, and 2,4-hexadiene, preferably 1,3-butadiene; and
(ii) a grafted thermoplastic copolymer grafted to the polymeric rubber, wherein the grafting thermoplastic copolymer comprises polymeric units derived from at least one of a vinyl aromatic monomer, preferably styrene, and a vinyl nitrile monomer, preferably acrylonitrile.

4. The thermoplastic composition of claim 3, wherein the first copolymer comprises a styrene-acrylonitrile copolymer (SAN) and the rubber modified polymer comprises a SAN grafted butadiene rubber.

5. The thermoplastic composition of claim 4, further comprising: an ethylene acrylic acid (EAA) copolymer in an amount from 2%-10% by weight of the composition, wherein the EAA copolymer comprises acrylic acid content in an amount from 1%-10% by weight of the EAA copolymer.

6. The thermoplastic composition of claim 5, further comprising: one or more further components in an amount from 0%-5% by weight of the composition.

7. The thermoplastic composition claim 6, wherein the one or more further components in the thermoplastic composition are selected from the group consisting of an impact modifier, a flow modifier, a reinforcing agent, an antioxidant, a heat stabilizer, a light stabilizer, an ultraviolet light stabilizer, an ultraviolet absorbing additive, a plasticizer, a lubricant, a releasing agent, an antistatic agent, melt processing additive, and any combination thereof.

8. The thermoplastic composition of claim 6, wherein the one or more further components comprises at least one of magnesium oxide (MgO), silicone fluid, ethylene bis stearamide (EBX) wax, and magnesium stearate.

9. The thermoplastic composition of claim 8, having a Notched Izod Impact strength of 3.0 kJ/m2 to 30.0 kJ/m2.

10. An electroplating process comprising:
molding a thermoplastic composition of claim 1 into a molded article;
optionally cleaning and/or rinsing the molded article;
contacting a surface of the molded article with a chemical agent to form a surface treated article; and
subjecting the surface treated article to conditions suitable to adhere one or more metal layers to at least a portion of a surface of the surface treated article to produce a metal plated molded article.

11. The electroplating process according to claim 10, wherein the chemical agent comprises a suspension of manganese oxide colloidal particles in a mineral acid mixture.

12. The electroplating process of claim 10, wherein the one or more metal layers are selected from the group consisting of copper, nickel, and chromium, preferably nickel.

13. The electroplating process of claim 10, wherein the metal plated molded article comprises a peel strength determined in accordance with ASTM B533-85 of greater than 0.4 N/mm.

14. A metal plated article comprising:
a metal layer;
a thermoplastic article, wherein (i) the metal layer is adhered onto at least a portion of a surface of the thermoplastic article and (ii) the thermoplastic article comprises:
a first copolymer in an amount from 30%-80% by weight of the composition, preferably from 45%-75% by weight of the composition, wherein the first copolymer comprises polymeric units derived from a vinyl aromatic monomer and a vinyl nitrile monomer;
a rubber modified polymer in an amount of 18%-50% by weight of the composition, preferably from 30%-45% by weight of the composition; and
a styrene maleic anhydride (SMA) copolymer in an amount from 2%-15% by weight of the composition,
wherein the SMA copolymer comprises a maleic anhydride content in an amount from 10%-30% by weight of the SMA copolymer, preferably from 12%-25% by weight of the SMA copolymer, more preferably from 15%-20% by weight of the SMA copolymer, and
wherein the SMA copolymer comprises a weight average molecular weight from 5,000 g/mol to 30,000 g/mol, preferably from 10,000 g/mol to 25,000 g/mol, more preferably from 15,000 g/mol to 20,000 g/mol.

15. The metal plated article of claim 14, wherein the metal plated article comprises an automotive part.

16. The thermoplastic composition of claim 5, wherein the EAA copolymer comprises acrylic acid content in an amount from 5%-7% by weight of the EAA copolymer.

17. The thermoplastic composition of claim 8, having a Notched Izod Impact strength of 4.0 kJ/m2 to 25.0 kJ/m2 when measured in accordance with ISO 180/1A.

18. The thermoplastic composition of claim 8, having a Notched Izod Impact strength of 5.0 kJ/m2 to 20.0 kJ/m2 when measured in accordance with ISO 180/1A.

19. The electroplating process according to claim 11, wherein the mineral acid mixture comprises sulfuric acid and/or phosphoric acid.

20. The metal plated article of claim 15, wherein the metal plated article comprises an electrical part.
